(19) United States
(12) Patent Application Publication
(10) Pub. No.: US 2019/0005831 A1
(43) Pub. Date: Jan. 3, 2019

(54) Virtual Reality Education Platform

(71) Applicant: Aquinas Learning, Inc., Stamford, CT (US)

(72) Inventor: Hugh Seaton, Stamford, CT (US)

(21) Appl. No.: 16/021,978

(22) Filed: Jun. 28, 2018

Related U.S. Application Data
(60) Provisional application No. 62/526,086, filed on Jun. 28, 2017.

(51) Int. Cl. G09B 5/06; G06F 3/01; G06F 3/0346; G02B 27/01; G06F 3/0354; G06F 3/0488; G09B 9/00

(52) U.S. Cl. CPC G09B 5/06; G06F 3/013; G06F 3/0346; G09B 9/00; G06F 3/03547; G06F 3/014; G06F 3/04883; G02B 27/017

(57) ABSTRACT

An immersive audiovisual training system including a content management computer for generating educational content, a content database for receiving and storing educational content, a viewing device for receiving the educational content from the content management computer via a network and a viewing device. The viewing device having sensors for generating a sensor signal indicative of movement of the viewing device relative to a base position, and a user interface for generating an input signal indicative of user commands. The viewing device also having a display, which receives a display signal indicative of the sensor signal, the input signal, and the educational content received by a processor, and presents the educational content. The educational content includes a training presentation and an enrichment module, and the enrichment module helps a trainee to understand the training presentation.

### CROSS-REFERENCE TO RELATED APPLICATIONS

This patent application claims the benefit, under 35 U.S.C. § 119(e), of U.S. Provisional Patent Application Ser. No. 62/526,086, filed on Jun. 28, 2017, the content of which is incorporated herein by reference in its entirety.

### TECHNICAL FIELD

The present disclosure relates generally to an immersive audiovisual training system, and more particularly to an immersive audiovisual training system that can be implemented in virtual reality where training presentations are displayed with enrichment modules to enhance a user's training experience.

### BACKGROUND

Training is a critical component in almost every company's success. There is an endless effort to improve the skillset of employees so that they can better perform the tasks required of them at work. Training with a coach or expert can be quite expensive, and so recorded videos are often used for professional training. According to the Association of Talent Development, about half of training is delivered in person, which means the other half is delivered electronically.

A major obstacle in professional training, particularly in electronic professional training, is keeping the trainee engaged and avoiding distraction. Known strategies of minimizing distraction involve keeping videos short and/or making the training entertaining.

Short training videos, i.e. micro-learning, is a strategy of training that breaks up the training into very small segments and tries to teach each segment separately and quickly, before the trainee has a chance to get distracted. This may work in some situations, but not everything can be broken up into tiny segments and progress may be very slow with this strategy.

Making videos fun and entertaining, i.e. gamefication, is another strategy used to hold a trainee's attention where the training is made into some sort of game. However, many skills cannot be taught as a game, many people are not interested in playing games, and games can be quite distracting to the learning process. This approach also adds a layer of complication in generating the programming, since making a game fun and educational is not an easy or formulaic task.

Previous approaches also fail to immerse the user in the training. No matter how interesting a lecture may be, people will eventually get distracted and their attention will be diverted elsewhere. A two-dimensional or even traditional three-dimensional presentation does not provide an immersive setting such that when individuals turn to their right or left they are still presented with educational content. In addition, if a trainee were watching a 2-dimensional video and became confused or had questions about what was being presented to them, they would ordinarily have to stop the video and look up the answer to their question, or interrupt the speaker (if it were a live setting) in order to ask their question. These processes of seeking support or clarification can be distracting to the trainee, but without the extra information the individual may become lost in the lesson and lose interest, thus making it even more difficult for the training to be effective.

Aspects of the present invention are directed to these and other problems.

### SUMMARY

According to an aspect of the present invention, an immersive audiovisual training system is provided including a content management computer, a content database, and a viewing device. The content management computer is for generating educational content. The content database is for receiving and storing educational content. The viewing device is for receiving the educational content from the content management computer via a network. The viewing device includes a sensor signal indicative of movement of the viewing device relative to a base position, with the sensor signal incorporating information from at least one sensor. The viewing device also includes an input signal indicative of user commands received by a user interface, and a display signal indicative of the sensor signal, the input signal, and the educational content received by a processor. The viewing device has a display for receiving the display signal and presenting the educational content. The educational content includes a training presentation and an enrichment module, and the enrichment module helps a trainee to understand the training presentation.

According to another aspect of the present invention, an immersive audiovisual training system is provided including a content management computer, a content database, and a viewing device. The content management computer is for generating educational content. The content database is for receiving and storing educational content. The viewing device is for receiving the educational content from the content management computer via a network. The viewing device includes a sensor signal indicative of movement of the viewing device relative to a base position, with the sensor signal incorporating information from at least one sensor. The viewing device also includes an input signal indicative of user commands received by a user interface, and a display signal indicative of the sensor signal, the input signal, and the educational content. The viewing device has a display for receiving the display signal and presenting the educational content. The educational content includes a training presentation and an enrichment module, and the enrichment module helps a trainee to understand the training presentation.

In addition to, or as an alternative to, one or more of the features described above, further aspects of the present invention can include one or more of the following features, individually or in combination:

the viewing device includes a controller for generating the display signal;

the at least one sensor includes a gyroscope;

the at least one sensor comprises an accelerometer;

the at least one sensor comprises a camera for tracking the eye movements of a user wearing the viewing device;

the viewing device is a virtual reality headset;

the user interface includes a microphone;

the user interface includes a touchpad for controlling the training presentation;

the touchpad allows the user to pause, start, and select a point in the training presentation to play from, and the touchpad allows the user to interact with the enrichment module to better understand the training presentation;

the user interface comprises a wired glove configured to interpret the hand movements of a user;

the wired glove allows the user to interact with a visual representation of a writing utensil shown on the display, to take notes on a digital notepad shown on the display;

the wired glove allows the user to interact with a visual representation of a keyboard shown on the display, to take notes on a digital notepad shown on the display;

a virtual space generator running on the processor, the virtual space generator receiving the input signal and the educational content and generating a virtual space indicative thereof;

an arranger, wherein the arranger receives the sensor signal and generates a display signal;

the display signal is indicative of a view of a portion of the virtual space, and the view of the portion of the virtual space is determined based on the base position of the viewing device;

the arranger updates the display signal to be indicative of a second view of a second portion of the virtual space, and the change from the first view of the first portion to the second view of the second portion is determined based on the movement of the viewing device relative to the base position as indicated by the sensor signal.

### BRIEF DESCRIPTION OF THE DRAWINGS

FIG. 1 is a block diagram showing an immersive audiovisual training system according to the present disclosure.

FIG. 2 is a block diagram showing an immersive audiovisual training system according to the present disclosure.

FIG. 3A is a representation of a user operating a viewing device according to the present disclosure.

FIG. 3B is a block diagram showing an arrangement of educational content in a virtual space according to the present disclosure.

FIG. 4A shows a user wearing a viewing device according to the present disclosure.

FIG. 4B shows a view on the display of the viewing device corresponding to the head position of the user shown in FIG. 4A.

FIG. 4C shows a user wearing a viewing device according to the present disclosure.

FIG. 4D shows a view on the display of the viewing device corresponding to the head position of the user shown in FIG. 4C.

FIG. 4E shows a user wearing a viewing device according to the present disclosure.

FIG. 4F shows a view on the display of the viewing device corresponding to the head position of the user shown in FIG. 4E.

### DETAILED DESCRIPTION

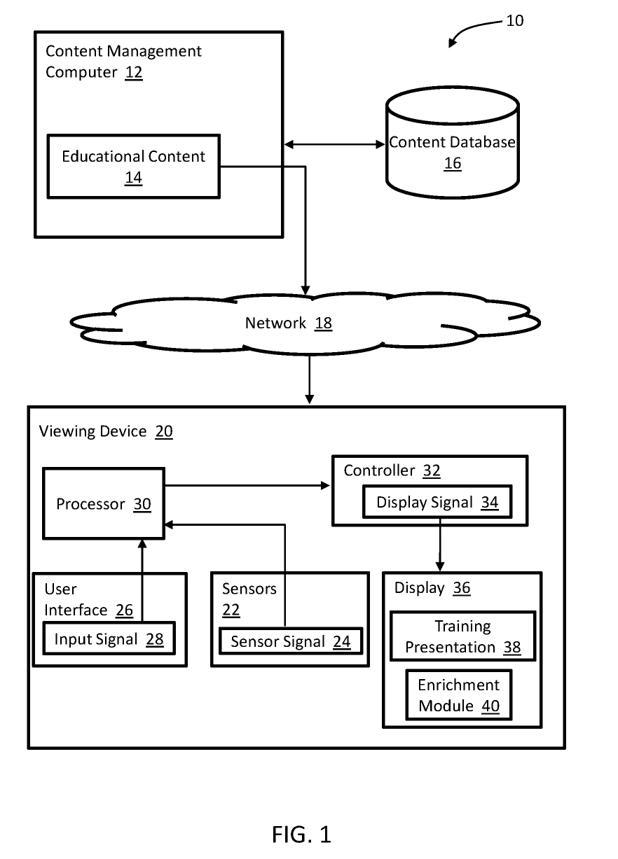

FIG. 1 shows an immersive audiovisual training system 10 having a content management computer 12 for generating educational content 14. A content database 16 receives and stores the educational content 14. The educational content 14 is sent from the content management computer 12 to a network 18, where it is then transmitted to a viewing device 20. The viewing device 20 has sensors 22 that produce a sensor signal 24, indicative of movement of the viewing device 20 relative to a base position. The viewing device 20 has a user interface 26, which produces an input signal 28 indicative of user commands received by the user interface 26. The viewing device 20 has a processor 30 for receiving the input signal 28 and the sensor signal 24, and sending this information to a controller 32, which produces a display signal 34. The display signal 34 is sent to a display 36. The display 36 presents the educational content 14 included in the display signal, which includes a training presentation 38 and an enrichment module 40. The enrichment module 40 helps a user (i.e. a trainee) to understand the training presentation 38.

The viewing device 20 may be any device capable of producing a virtual reality environment, i.e. realistic images, sounds, and other stimuli that replicate a real environment or create an imaginary setting, simulating a user's physical presence in this environment. The viewing device 20 may be a virtual reality headset such as the Oculus Rift®, Samsung Gear VR®, Google Daydream View®, HTC Vive®, Sony Playstation VR®, or similar devices. The viewing device 20 may also be a portable computing device or a smart phone, which can either be adapted to be worn by a user via a head-mount, or simply held up to a user's eyes by hand. The viewing device 20 may also be implemented via augmented reality devices such as Google Glass®, or other devices capable of both augmented and virtual reality such as contact lens displays, laser projected images onto the eye, holographic technology, or any other devices and technologies known by those of skill in the art having the benefit of the present disclosure.

The user interface 26 may include a microphone, a touchpad, buttons, and/or wired gloves. The microphone allows a user to control the training presentation using voice commands, while the touchpad/buttons would allow a user to input commands using their hands. Wired gloves would allow a wider range of input using the hands, such as allowing a user to interact with a visual representation of a writing utensil shown on the display in order to write notes on a digital notepad shown on the display, or type via interaction with a visual representation of a keyboard shown on the display. Wired gloves may include haptic technology in order to enhance the user's ability to interact with the enrichment module 40 or the visual keyboard. These features provide the benefit of further maintaining the user's focus during training by enhancing the immersion experience.

The user interface 26 may also be used to allow the user to interact with other users or a teacher (either real or artificially intelligent simulations thereof) to ask questions or engage with the educational content 14. The user may pause, start, and select a point in the training presentation to play from using the user interface 26. The user may resize or reposition the training presentation 38 or enrichment module 40, or interact with the enrichment module 40 so as to, e.g. look up a term in a glossary that was said in the training presentation 38 but was unfamiliar to the user. In this way, the user interface 26 enhances the ability of a user to interact with a variety of useful aids and educational support offered through the enrichment module 40 while the training presentation 38 is being presented to the user.

The sensors 22 may include a gyroscope, an accelerometer, a camera, electrodes, or some combination thereof. The sensors 22 are designed to track the position and movement of the head and/or the eyes of a user wearing the viewing device 20, which can be done by detecting the change in the angular momentum using the gyroscope, the turning of the head using the accelerometer, the position and movement of the retina using the camera or the electrodes, or any other method known by those of skill in the art having the benefit of the present disclosure. The sensors 22 allow the viewing device 20 to better simulate reality by adapting the view provided on the display 36 to coordinate with the movements of a user's head. In this way, the user is immersed in the training and can seamlessly direct their attention from the training presentation 38 to the enrichment module 40 by simply turning their head. Sensors 22 may also include biometric sensors including heart rate monitors, breathing monitors, and/or thermometers. Feedback from the sensors 22 can therefore be used for additional tasks such as detecting when the trainee is confused or falling asleep. This information can be used in a variety of ways, including for real-time alterations to the content being provided in the enrichment module 40 so as to re-engage the user with the training. If the sensors 22 indicate the trainee is confused, the training system 10 may automatically pause the training presentation 38 and prompt the user to interact with content in the enrichment module 40.

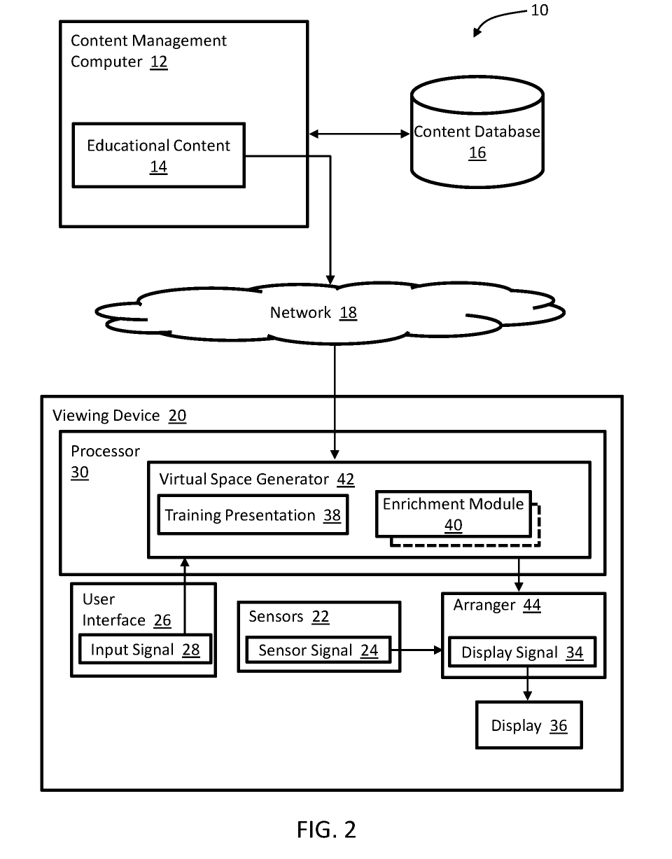

FIG. 2 shows the immersive audiovisual training system 10 with the educational content 14 being sent directly to a virtual space generator 42 running on the processor 30. The virtual space generator 42 receives the input signal 28 from the user interface 26, and from these two signals generates a virtual space 48 (not shown in this figure) including the training presentation 38 and an enrichment module 40. The virtual space 48 is then transmitted to an arranger 44, which generates the display signal 34 incorporating the information from the sensor signal 24. The display 36 receives the display signal 34 and displays a view of a portion of the virtual space 48.

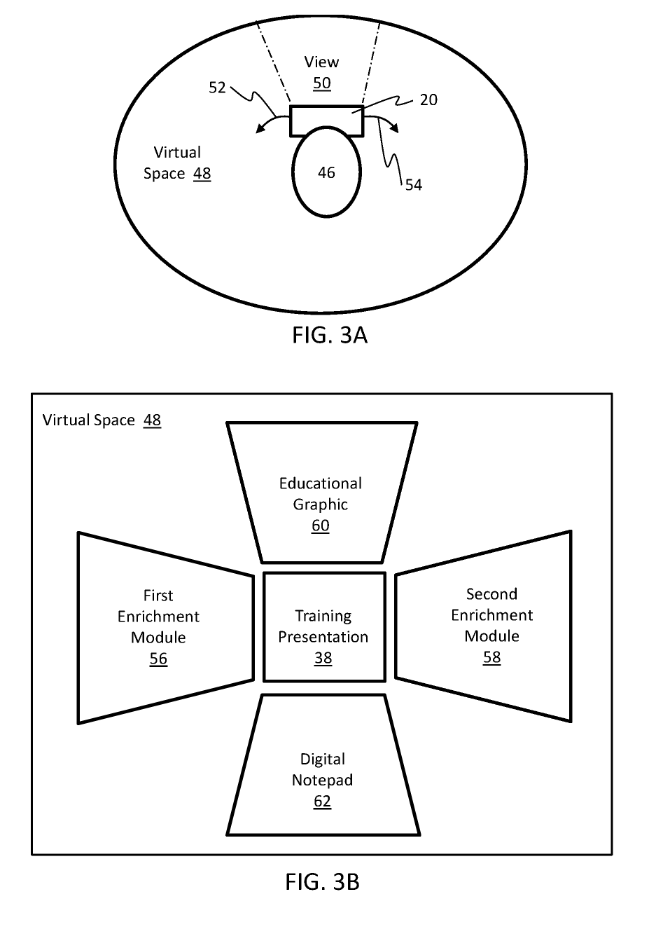

FIG. 3A shows a user 46 wearing the viewing device 20. A virtual space 48 is represented in this figure as a circle surrounding the user 46, which represents that the virtual space 48 exists as a 360-degree environment simulating the user 46 actually being present in this environment. The view 50 is represented here as a portion of the virtual space 48 surrounding the user 46. In reality, the view 50 is what is being shown on the display 36, and the sensors 22 are used to track the movement of the viewing device 20 in order to update the view 50 to correspond with the movement 52, 54 of the device 20. Movement arrows 52, 54 indicate that the user 46 can move his/her head (and consequently move the viewing device 20) to change the view 50 of the virtual space 48.

FIG. 3B shows an exemplary schematic of the virtual space 48, where the training presentation 38 is displayed in the center of the virtual space 48. A first enrichment module 56 is displayed to the left of the training presentation 38, and a second enrichment module 58 is displayed to the right of the training presentation 38. An educational graphic 60 is shown above the training presentation 38, and a digital notepad 62 is displayed below the training presentation 38. The view 50 only shows a portion of the virtual world 48, such that, for example, the first enrichment module 56 and the second enrichment module 58 could not be viewed by a user 46 at the same time (in this particular arrangement of modules). Thus, a user 46 must turn their head to view the portion of the virtual space 48 that they want to see.

For example, a user 46 is receiving training covering how to enter data into a MS Office Excel® spreadsheet to perform a certain task. The training presentation 38 shows a presenter explaining the process, the first enrichment module 56 shows the data being entered in Excel on a computer screen, the second enrichment module 58 shows the definition of a word the presenter just used, the educational graphic 60 shows a chart demonstrating how much time is saved by performing the task in this fashion, and the digital notepad 62 shows the notes taken by the user 46 during the training. If the user 46 is watching the training presentation 38 and the presenter uses a word they don't understand, they can seamlessly move their head right 54 to view the definition of the word in the second enrichment module 58, which is either automatically displayed or selected by the user 46. If the user 46 is confused regarding how the presenter is accomplishing a certain step in Excel, they can move their head left 52 to see an actual example of the process being done in the first enrichment module 56. If the user 46 loses focus and looks up at the ceiling, they would see the educational graphic 60 showing them the value of the skill they are learning and potentially motivating them to keep focus on the lesson. When the user 46 hears something helpful or interesting, they can take notes on the digital notepad 62, and refer to the notes later on in the presentation or after the presentation is complete.

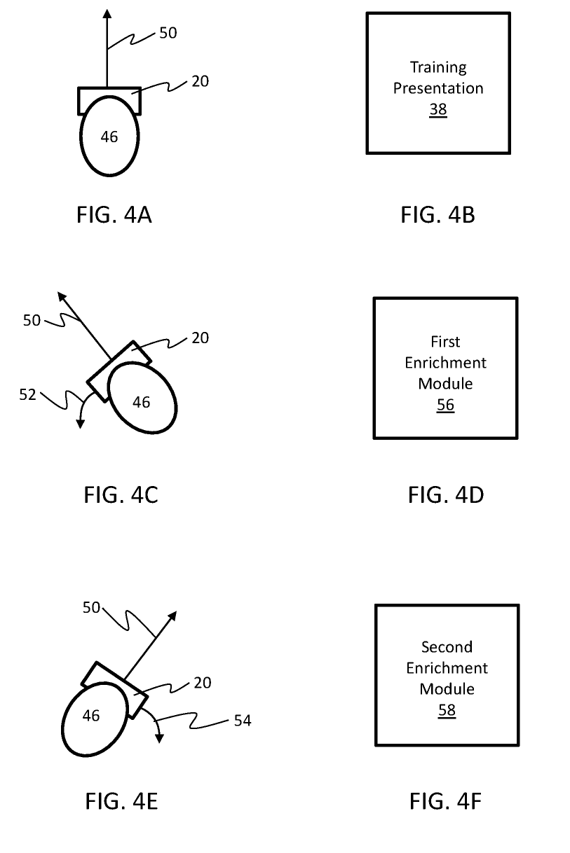

FIG. 4A shows a first position of the viewing device 20 and the user's head 46. FIG. 4B shows the training presentation 38, which is displayed within the view 50 that corresponds with the head position in FIG. 4A.

FIG. 4C demonstrates that if the user 46 turns their head and the viewing device 20 to the left, the first enrichment module 56 is then displayed within the view 50, as shown in FIG. 4D.

FIG. 4E demonstrates that if the user 46 turns their head and the viewing device 20 to the right, the second enrichment module 58 is then displayed within the view 50, as shown in FIG. 4F.

The enrichment module 40 provides educational content 14 that can supplement, clarify, reiterate, or similarly complement the educational content 14 provided in the training presentation 38. By having multiple enrichment modules, e.g. as shown in FIG. 3B, a user can be literally surrounded by the educational content 14 of the training or lesson, such that rather than being distracted by their surroundings, a user 46 is helped by their surroundings no matter where they look. The enrichment module 40 also allows supplementary content to be provided simultaneously with the training presentation 38, so that the two forms of instruction can be appreciated together and at the same time. Similarly, the modules and training presentation 38 can each be either 2D or 3D to provide maximum benefit to the user or direct their attention. The enrichment module 40 may take a variety of forms, including as a dictionary, glossary, chart, table, drawing, schematic, bullet points for key aspects of the lesson or learning goals, videos demonstrating principles or processes of the lesson, related lessons or content for deeper understanding of something being covered, more difficult or less difficult variations of the lessons, questions and/or answers pertaining to the content being covered, and any other educational content known by those of skill in the art having the benefit of the present disclosure.

The immersive audiovisual training system 10 offers several advantages over known training systems. Among other things, the immersive audiovisual training system 10 provides educational content 14 to a user 46 via a training presentation 38 and an enrichment module 40 in order to enhance the learning experience and further the user's engagement with the educational content 14. In addition, the immersive audiovisual training system 10 provides an immersive experience to the user 46 that minimizes distractions ordinarily present in a person's surroundings. The immersive audiovisual training system 10 also provides alternative means of explaining the same point to accommodate different learning styles simultaneously, and allows users to switch between these various forms of learning through a seamless and natural interface. Similarly the immersive audiovisual training system 10 not only minimizes loss of interest due to confusion but can respond to a loss of interest via prompts or alterations provided through the enrichment modules. The immersive audiovisual training system 10 also allows a presenter to avoid having to switch back and forth between different teaching styles or different teaching tools/demonstratives, since the immersive audiovisual training system 10 is digitally provided with the ability for the enrichment module 40 to be provided at the same time as the training presentation 38, e.g. a real-world might require a presenter pause to set up or conduct an experiment while the immersive audiovisual training system 10 avoids these delays and distractions in the lesson. The immersive audiovisual training system 10 also provides the ability to take notes during the training and within the virtual space 48 of the training in order to enhance the user's immersion in the system 10 and provide equivalent or superior utility over real-world note taking techniques.

While several embodiments have been disclosed, it will be apparent to those of skill in the art having the benefit of the present disclosure that aspects of the present invention include many more embodiments and implementations. Accordingly, aspects of the present invention are not to be restricted except in light of the attached claims and their equivalents. It will also be apparent to those of skill in the art having the benefit of the present disclosure that variations and modifications can be made without departing from the true scope of the present disclosure. For example, in some instances, one or more features disclosed in connection with one embodiment can be used alone or in combination with one or more features of one or more other embodiments.

What is claimed is:

1. An immersive audiovisual training system, comprising:
a content management computer for generating educational content;
a content database for receiving and storing educational content;
a viewing device for receiving the educational content from the content management computer via a network;
the viewing device including:
a sensor signal indicative of movement of the viewing device relative to a base position, the sensor signal incorporating information from at least one sensor;
an input signal indicative of user commands received by a user interface;
a display signal indicative of the sensor signal, the input signal, and the educational content received by a processor; and
a display for receiving the display signal and presenting the educational content;
wherein the educational content includes a training presentation and an enrichment module, and the enrichment module helps a trainee to understand the training presentation.

2. The immersive audiovisual training system of claim 1, wherein the viewing device further comprises a controller for generating the display signal.

3. The immersive audiovisual training system of claim 1, wherein the at least one sensor comprises a gyroscope.

4. The immersive audiovisual training system of claim 1, wherein the at least one sensor comprises an accelerometer.

5. The immersive audiovisual training system of claim 1, wherein the at least one sensor comprises a camera for tracking the eye movements of a user wearing the viewing device.

6. The immersive audiovisual training system of claim 1, wherein the viewing device is a virtual reality headset.

7. The immersive audiovisual training system of claim 1, wherein the user interface comprises a microphone.

8. The immersive audiovisual training system of claim 1, wherein the user interface comprises a touchpad for controlling the training presentation.

9. The immersive audiovisual training system of claim 8, wherein the touchpad allows the user to pause, start, and select a point in the training presentation to play from; and
the touchpad allows the user to interact with the enrichment module to better understand the training presentation.

10. The immersive audiovisual training system of claim 1, wherein the user interface comprises a wired glove configured to interpret the hand movements of a user.

11. The immersive audiovisual training system of claim 10, wherein the wired glove allows the user to interact with a visual representation of a writing utensil shown on the display, to take notes on a digital notepad shown on the display.

12. The immersive audiovisual training system of claim 10, wherein the wired glove allows the user to interact with a visual representation of a keyboard shown on the display, to take notes on a digital notepad shown on the display.

13. An immersive audiovisual training system, comprising:
a content management computer for generating educational content;
a content database for receiving and storing educational content;
a viewing device for receiving the educational content from the content management computer via a network;
the viewing device including:
a sensor signal indicative of movement of the viewing device relative to a base position, the sensor signal incorporating information from at least one sensor;
an input signal indicative of user commands received by a user interface;
a display signal indicative of the sensor signal, the input signal, and the educational content; and
a display for receiving the display signal and presenting the educational content;
wherein the educational content includes a training presentation and an enrichment module, and the enrichment module helps a trainee to understand the training presentation.

14. The immersive audiovisual training system of claim 14, further comprising a virtual space generator running on the processor, the virtual space generator receiving the input signal and the educational content and generating a virtual space indicative thereof.

15. The immersive audiovisual training system of claim 14, further comprising an arranger, wherein the arranger receives the sensor signal and generates a display signal.

16. The immersive audiovisual training system of claim 15, wherein the display signal is indicative of a view of a portion of the virtual space, and the view of the portion of the virtual space is determined based on the base position of the viewing device.

17. The immersive audiovisual training system of claim 16, wherein the arranger updates the display signal to be indicative of a second view of a second portion of the virtual space, and the change from the first view of the first portion to the second view of the second portion is determined based on the movement of the viewing device relative to the base position as indicated by the sensor signal.

18. The immersive audiovisual training system of claim 13, wherein the at least one sensor comprises a camera for tracking the eye movements of a user wearing the viewing device.

19. The immersive audiovisual training system of claim 13, wherein the viewing device is a virtual reality headset.

20. The immersive audiovisual training system of claim 1, wherein the user interface comprises a touchpad for controlling the training presentation.
